(19) United States
(12) Patent Application Publication
(10) Pub. No.: US 2020/0391508 A1
(43) Pub. Date: Dec. 17, 2020

(54) THERMAL SENSE MONITORS FOR FLUID EJECTION DIES

(71) Applicant: Hewlett-Packard Development Company, L.P., Spring, TX (US)

(72) Inventors: Gary G. Lutnesky, Corvallis, OR (US); Tony Len Storey, Corvallis, OR (US)

(73) Assignee: Hewlett-Packard Development Company, L.P., Spring, TX (US)

(21) Appl. No.: 16/955,825

(22) PCT Filed: Mar. 9, 2018
(86) PCT No.: PCT/US2018/021756

§ 371 Date: Jun. 19, 2020

(51) Int. Cl. B41J 2/045; G01K 1/02; G01K 7/00

(52) U.S. Cl. CPC B41J 2/04563; G01K 7/00; G01K 1/026; B41J 2/0458

(57) ABSTRACT

A thermal sense monitor includes a shared thermal sense line, a biasing circuit, and a clamping circuit. The shared thermal sense line sequentially receives a temperature signal from each of a plurality of fluid ejection dies. The biasing circuit supplies a current to the shared thermal sense line to bias a temperature sensor of each of the plurality of fluid ejection dies. The clamping circuit is electrically coupled to the shared thermal sense line to clip the temperature signal.

### BACKGROUND

An inkjet printing system, as one example of a fluid ejection system, may include a printhead, an ink supply which supplies liquid ink to the printhead, and an electronic controller which controls the printhead. The printhead, as one example of a fluid ejection device, ejects drops of ink through a plurality of nozzles or orifices and toward a print medium, such as a sheet of paper, so as to print onto the print medium. In some examples, the orifices are arranged in at least one column or array such that properly sequenced ejection of ink from the orifices causes characters or other images to be printed upon the print medium as the printhead and the print medium are moved relative to each other.

### BRIEF DESCRIPTION OF THE DRAWINGS

FIG. 1 is a block diagram illustrating one example of a thermal sense monitor.

FIG. 2 is a schematic diagram illustrating another example of a thermal sense monitor.

FIG. 3 is a circuit diagram illustrating one example of a clamping circuit.

FIG. 4 is a block diagram illustrating one example of a fluid ejection device.

FIG. 5 illustrates one example of a fluid ejection die.

FIG. 6 illustrates example thermal sense sampling waveforms.

FIG. 7 illustrates another example of a fluid ejection device.

FIG. 8 is a block diagram illustrating one example of a fluid ejection system.

FIG. 9 is a block diagram illustrating another example of a fluid ejection device.

FIG. 10 is a flow diagram illustrating one example of a method for monitoring the temperature of a plurality of fluid ejection dies.

FIGS. 11 and 12 are flow diagrams illustrating example additional processes for the method of FIG. 10.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

To achieve optimal fluid ejection die performance, the fluid ejection die temperatures should be monitored and controlled. A single thermal sense monitor circuit may be used to monitor the temperature of each of a plurality of dies by sequentially switching between the dies to receive and process a temperature signal from each die. Switching between a plurality of dies to sequentially monitor the temperature of each die via the thermal sense monitor circuit may result in noise on the temperature signal line input to the thermal sense monitor circuit.

According, disclosed herein is a fluid ejection system including a plurality of fluid ejection dies and a thermal sense monitor circuit. Each die includes a temperature sensor. The thermal sense monitor circuit may include a shared thermal sense line coupled to a local thermal sense line of each die and a biasing circuit to bias the temperature sensor of each die via the shared thermal sense line and each local thermal sense line. The thermal sense monitor circuit may also include a clamping circuit to clip the temperature signal on the shared thermal sense line and a controller to sequentially select each die to output a temperature signal to the shared thermal sense line. The clamping circuit may include a precision gate threshold metal-oxide-semiconductor field-effect-transistor (MOSFET) to clip a voltage of the temperature signal at the threshold voltage of the MOSFET. The clamping circuit reduces or prevents noise on the shared thermal sense line when switching between the dies.

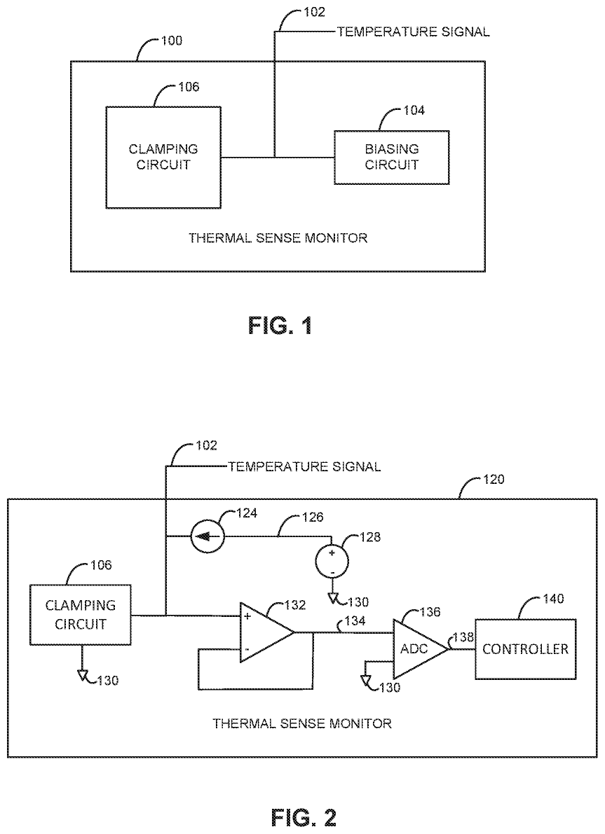

FIG. 1 is a block diagram illustrating one example of a thermal sense monitor 100. Thermal sense monitor 100 includes a shared thermal sense line 102, a biasing circuit 104, and a clamping circuit 106. Shared thermal sense line 102 is electrically coupled to biasing circuit 104 and clamping circuit 106. Shared thermal sense line 102 sequentially receives a temperature signal from each of a plurality of fluid ejection dies (not shown). Biasing circuit 104 supplies a current to shared thermal sense line 102 to bias a temperature sensor of each of the plurality of fluid ejection dies. Clamping circuit 106 clips the temperature signal on shared thermal sense line 102. By clipping the temperature signal on shared thermal sense line 102, clamping circuit 106 reduces or prevents noise on shared thermal sense line 102 when switching between the plurality of fluid ejection dies.

FIG. 2 is a schematic diagram illustrating another example of a thermal sense monitor 120. Thermal sense monitor 120 includes shared thermal sense line 102, clamping circuit 106, a current source 124, a voltage source 128, an operational amplifier 132, an analog to digital convertor (ADC) 136, and a controller 140. Shared thermal sense line 102 is electrically coupled to clamping circuit 106, the positive terminal of current source 124, and the non-inverting input of operational amplifier 132. The negative terminal of current source 124 is electrically coupled to the positive terminal of voltage source 128. The output of operational amplifier 132 is electrically coupled to the inverting input of operational amplifier 132 and the input of ADC 136 through a signal line 134. Clamping circuit 106, the negative terminal of voltage source 128, and ADC 136 are electrically coupled to a common or ground node 130. The output of ADC 136 is electrically coupled to an input of controller 140 through a signal line 138.

As previously described above with reference to FIG. 1, shared thermal sense line 102 sequentially receives a temperature signal from each of a plurality of fluid ejection dies and clamping circuit 106 clips the temperature signal on shared thermal sense line 102. Current source 124 and voltage source 128 form a biasing circuit, such as biasing circuit 104 of FIG. 1, to supply a current to shared thermal sense line 102 to bias a temperature sensor of each of the plurality of fluid ejection dies. In one example, voltage source 128 supplies 3.3 VDC and current source 124 supplies 18 μA to bias each temperature sensor. Controller 140 may sequentially select each of the plurality of fluid ejection dies to output a temperature signal from the temperature sensor of each of the plurality of fluid ejection dies to shared thermal sense line 102.

Operational amplifier 132 is configured as a unity gain amplifier (i.e., a buffer) to buffer the temperature signal on shared thermal sense line 102. ADC 136 receives the buffered temperature signal and converts the temperature signal to a digital value. ADC 136 outputs the digital value to controller 140. Controller 140 may use the digital value of the temperature signal from each of the plurality of fluid ejection dies to control the temperature of each of the fluid ejection dies. Controller 140 may control the temperature of each of the fluid ejection dies by controlling a heating element disposed on each of the fluid ejection dies. In other examples, controller 140 may use the digital value of the temperature signal from each of the plurality of fluid ejection dies for other suitable purposes. Controller 140 may include a microcontroller, an application-specific integrated circuit (ASIC), or other suitable logic circuitry.

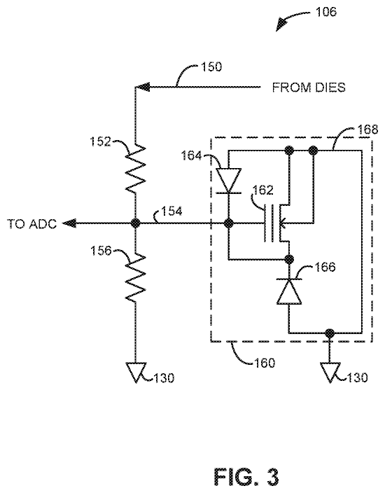

FIG. 3 is a circuit diagram illustrating one example of a clamping circuit 106. Clamping circuit 106 includes resistors 152 and 156 and a precision gate threshold MOSFET 160. Precision gate threshold MOSFET 160 includes diodes 164 and 166 and a transistor 162. One terminal of resistor 152 is electrically coupled to a shared thermal sense line 150. Shared thermal sense line 150 is electrically coupled to a plurality of fluid ejection dies. The other terminal of resistor 152 is electrically coupled to one terminal of resistor 156, the cathode of diode 164, the gate and the drain of transistor 162, and the cathode of diode 166 through a signal line 154. The anode of diode 164, the source and the body of transistor 162, and the anode of diode 166 are electrically coupled to a common or ground node 130 through a signal line 168. The other terminal of resistor 156 is electrically coupled to common or ground node 130. Signal line 154 is electrically coupled to an ADC, such as ADC 136 of FIG. 2.

Precision gate threshold MOSFET 160 clips the voltage on signal line 154 at the threshold voltage of precision gate threshold MOSFET 160. In one example, resistor 152 is 43 KΩ and resistor 156 is 3.3 MΩ. In one example, when the voltage on signal path 154 reaches 1.8 V, transistor 162 starts to turn on, and by 1.9 V is fully on. In this way, the voltage on signal line 154 is clipped at 1.9 V by conducting voltage above the threshold to common or ground node 130 through the drain to the source of transistor 162. Precision gate threshold MOSFET 160 is largely unaffected by temperature (e.g., has a temperature coefficient less than 2.5 mV/° C.), allowing for a wide operating swing while maintaining the precision voltage threshold for clipping. Precision gate threshold MOSFET 160 may also have a rapid clamping response less than 15 ns. Clamping circuit 106 prevents the voltage on signal line 154 from railing due to a temporary fluid ejection die disconnect time, such as when transitioning the shared thermal sense line from connection to one die to connection to another die.

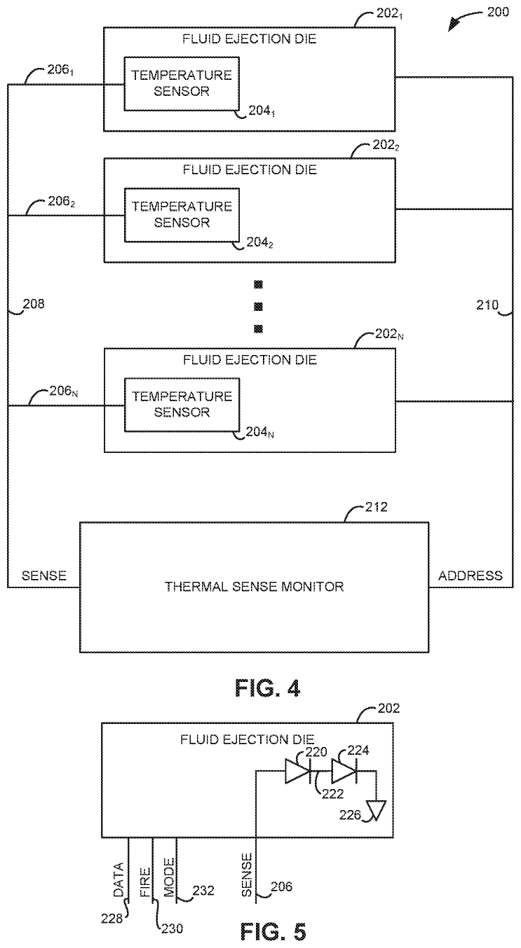

FIG. 4 is a block diagram illustrating one example of a fluid ejection device 200. Fluid ejection device 200 includes a plurality of fluid ejection dies 202₁ to 202_{N}, where “N” is any suitable number of fluid ejection dies, and a thermal sense monitor 212. In one example, thermal sense monitor 212 includes thermal sense monitor 100 previously described and illustrated with reference to FIG. 1 or thermal sense monitor 120 previously described and illustrated with reference to FIG. 2. Each fluid ejection die 202₁ to 202_{N} includes a temperature sensor 204₁ to 204_{N}, respectively. Each temperature sensor 204₁ to 204_{N} is electrically coupled to a temperature sense signal input of thermal sense monitor 212 through a local thermal sense line 206₁ to 206_{N} and a shared thermal sense line 208, respectively. An address output of thermal sense monitor 212 is electrically coupled to an address input of each fluid ejection die 202₁ to 202_{N} through an address signal path 210.

Each fluid ejection die 202₁ to 202_{N} enables its temperature sensor 204₁ to 204_{N} in response to receiving an address signal corresponding to the fluid ejection die 202₁ to 202_{N}, respectively. Thermal sense monitor 212 sequentially selects each temperature sensor 204₁ to 204_{N} of each of the plurality of fluid ejection dies 202₁ to 202_{N} to output a temperature signal to shared thermal sense line 208 and clips the temperature signal on shared thermal sense line 208.

FIG. 5 illustrates one example of a fluid ejection die 202. In one example, fluid ejection die 202 provides each fluid ejection die 202₁ to 202_{N} of FIG. 4. Fluid ejection die 202 includes a temperature sensor, which includes diodes 220 and 224 in a diode stack. The anode of diode 220 is electrically coupled to a local thermal sense line 206. The cathode of diode 220 is electrically coupled the anode of diode 224 through a signal line 222. The cathode of diode 224 is electrically coupled to a common or ground node 226. Fluid ejection die 202 also includes a data input line 228, a fire command line 230, and a mode command line 232 to control the firing of nozzles (not shown) of fluid ejection die 202.

In response to fluid ejection die 202 receiving the address signal corresponding to fluid ejection die 202, diode stack 220 and 224 is enabled to receive a biasing current from a thermal sense monitor through local thermal sense line 206. In response to the biasing current, diode stack 220 and 224 outputs a temperature signal (i.e., voltage) on local thermal sense line 206 corresponding to the temperature of fluid ejection die 202.

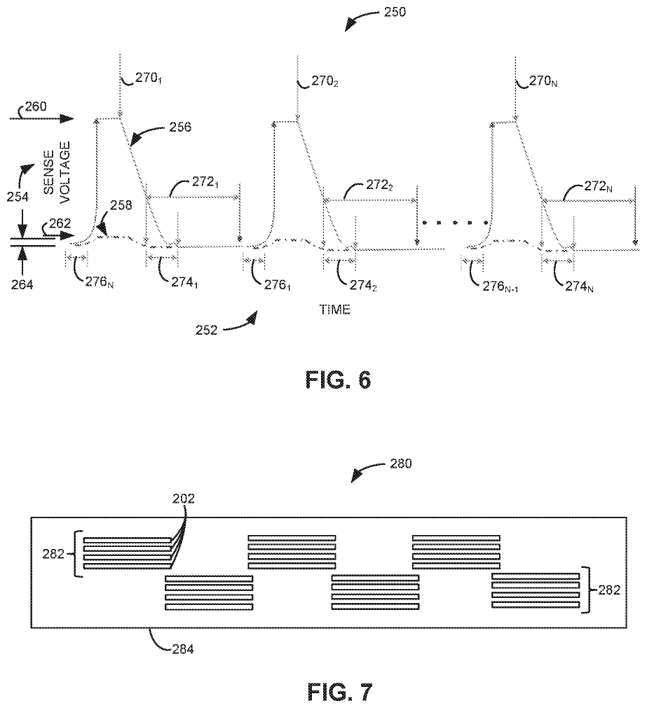

FIG. 6 illustrates example thermal sense sampling waveforms 250. Thermal sense sampling waveforms 250 includes time on x-axis 252 versus sense voltage on y-axis 254. Thermal sense sampling waveforms 250 include a waveform 256 represented by a solid line and waveform 258 represented by a dashed line. Waveforms 256 and 258 are identical during a temperature sampling time. Waveform 256 illustrates the thermal sense sampling signal when not using a clamping circuit within the thermal sense monitor. Waveform 258 illustrates the thermal sense sampling signal when using a clamping circuit within the thermal sense monitor as previously described herein. Without the clamping circuit, waveform 256 rails at the biasing circuit supply voltage (e.g., 3.3 VDC) as indicated at 260 when switching from one fluid ejection die to another. The railing is due to the temporary disconnection from a fluid ejection die, such as when transitioning from the sense line connection of one die to the next die, or when the loop for sensing the die temperatures starts over from the first die.

With the clamping circuit, waveform 258 is clipped at a voltage as indicated at 262 just above (e.g., 0.1-0.2 VDC) the thermal sense voltage range (e.g., 0-1.7 VDC) as indicated at 264. According, at 270₁ to 270_{N} each fluid ejection die 1 to N is sequentially selected to output a temperature signal to the shared thermal sense line, respectively. The temperature signal may be converted to a digital value by an ADC after a sample delay period 272₁ to 272_{N} for each selected fluid ejection die 1 to N, respectively. Due to the clamping circuit, an additional sampling margin 274₁ to 274_{N} on the falling edge of each switched local thermal sense line and an additional sampling margin 276₁ to 276_{N} on the rising edge of each switched local thermal sense line is available for each sampling period, respectively. This allows for extra room when the position of the ADC trigger sample delay is adjusted, thus eliminating false readings and noise due to settling time after switching in a temperature sensor and rise time after a temperature sensor is turned off.

FIG. 7 illustrates one example of a fluid ejection device 280. Fluid ejection device 280 includes six squads (i.e., groups) 282, where each squad includes four fluid ejection dies 202, molded into a molded body 284. In one example, fluid ejection device 280 is a wide-array or multi-head printhead assembly with squads 282 arranged and aligned in one or more overlapping rows such that squads 282 in one row overlap at least one squad 282 in another row. As such, fluid ejection device 280 may span a nominal page width or a width shorter or longer than a nominal page width. For example, the printhead assembly may span 8.5 inches of a Letter size print medium or a distance greater than or less than 8.5 inches of the Letter size print medium. In this example, each squad 282 may include a fluid ejection die 202 to eject ink of the following colors: cyan, magenta, yellow, and black (CMYK). While six squads 282 with each squad including four fluid ejection dies 202 are illustrated as being molded into molded body 284, the number of squads 282 and the number of fluid ejection dies 202 within each squad molded into molded body 284 may vary.

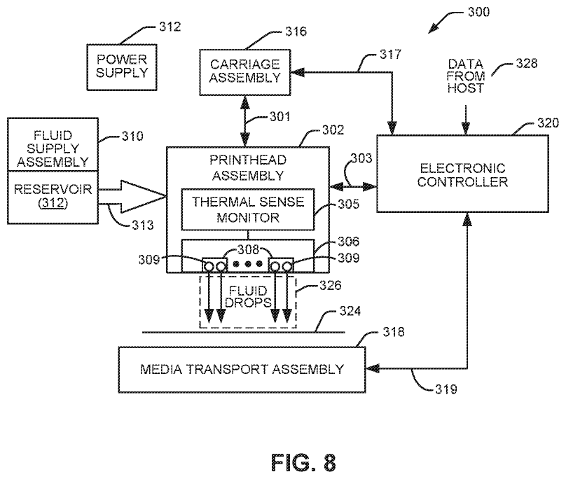

FIG. 8 is a block diagram illustrating one example of a fluid ejection system 300. Fluid ejection system 300 includes a fluid ejection assembly, such as printhead assembly 302, and a fluid supply assembly 310, such as an ink supply assembly. In the illustrated example, fluid ejection system 300 also includes a carriage assembly 316, a print media transport assembly 318, an electronic controller 320, and at least one power supply 312 that provides power to the various electrical components of fluid ejection system 300. While the following description provides examples of systems and assemblies for fluid handling with regard to ink, the disclosed systems and assemblies are also applicable to the handling of fluids other than ink.

Printhead assembly 302 includes a thermal sense monitor 305 electrically coupled to at least one printhead or fluid ejection device 306. Fluid ejection device 306 includes at least two fluid ejection dies 308, where each fluid ejection die 308 ejects drops of fluid through a plurality of orifices or nozzles 309. In one example, the drops are directed toward a medium, such as print media 324, so as to print onto print media 324. In one example, print media 324 includes any type of suitable sheet material, such as paper, card stock, transparencies, Mylar, fabric, and the like. In another example, print media 324 includes media for three-dimensional (3D) printing, such as a powder bed, or media for bioprinting and/or drug discovery testing, such as a reservoir or container. In one example, nozzles 309 are arranged in at least one column or array such that properly sequenced ejection of ink from nozzles 309 causes characters, symbols, and/or other graphics or images to be printed upon print media 324 as printhead assembly 302 and print media 324 are moved relative to each other.

Each Fluid ejection die 308 may be a fluid ejection die 202 previously described and illustrated with reference to FIG. 5. Thermal sense monitor 305 may be thermal sense monitor 100 or 120 as previously described and illustrated with reference to FIG. 1 or 2, respectively. Thermal sense monitor 305 is electrically coupled to each fluid ejection die 308 to monitor the temperature of each fluid ejection die 308 as previously described herein.

Fluid supply assembly 310 supplies fluid to printhead assembly 302 and includes a reservoir 312 for storing fluid. As such, in one example, fluid flows from reservoir 312 to printhead assembly 302. In one example, printhead assembly 302 and fluid supply assembly 310 are housed together in an inkjet or fluid-jet print cartridge or pen. In another example, fluid supply assembly 310 is separate from printhead assembly 302 and supplies fluid to printhead assembly 302 through an interface connection 313, such as a supply tube and/or valve.

Carriage assembly 316 positions printhead assembly 302 relative to print media transport assembly 318, and print media transport assembly 318 positions print media 324 relative to printhead assembly 302. Thus, a print zone 326 is defined adjacent to nozzles 309 in an area between printhead assembly 302 and print media 324. In one example, printhead assembly 302 is a scanning type printhead assembly such that carriage assembly 316 moves printhead assembly 302 relative to print media transport assembly 318. In another example, printhead assembly 302 is a non-scanning type printhead assembly such that carriage assembly 316 fixes printhead assembly 302 at a prescribed position relative to print media transport assembly 318.

Electronic controller 320 communicates with printhead assembly 302 through a communication path 303, carriage assembly 316 through a communication path 317, and print media transport assembly 318 through a communication path 319. In one example, when printhead assembly 302 is mounted in carriage assembly 316, electronic controller 320 and printhead assembly 302 may communicate via carriage assembly 316 through a communication path 301. Electronic controller 320 may also communicate with fluid supply assembly 310 such that, in one implementation, a new (or used) fluid supply may be detected.

Electronic controller 320 receives data 328 from a host system, such as a computer, and may include memory for temporarily storing data 328. Data 328 may be sent to fluid ejection system 300 along an electronic, infrared, optical or other information transfer path. Data 328 represent, for example, a document and/or file to be printed. As such, data 328 form a print job for fluid ejection system 300 and includes at least one print job command and/or command parameter.

In one example, electronic controller 320 provides control of printhead assembly 302 including timing control for ejection of fluid drops from nozzles 309. As such, electronic controller 320 defines a pattern of ejected fluid drops which form characters, symbols, and/or other graphics or images on print media 324. Timing control and, therefore, the pattern of ejected fluid drops, is determined by the print job commands and/or command parameters. In one example, logic and drive circuitry forming a portion of electronic controller 320 is located on printhead assembly 302. In another example, logic and drive circuitry forming a portion of electronic controller 320 is located off printhead assembly 302.

Electronic controller 320 may also receive the sensed temperature from each of the at least two fluid ejection dies 308 via thermal sense monitor 305. Electronic controller 320 may use the sensed temperature from each of the at least two fluid ejection dies 308 for numerous purposes, such as to control the temperature of each of the at least two fluid ejection dies 308 to achieve optimal printing performance.

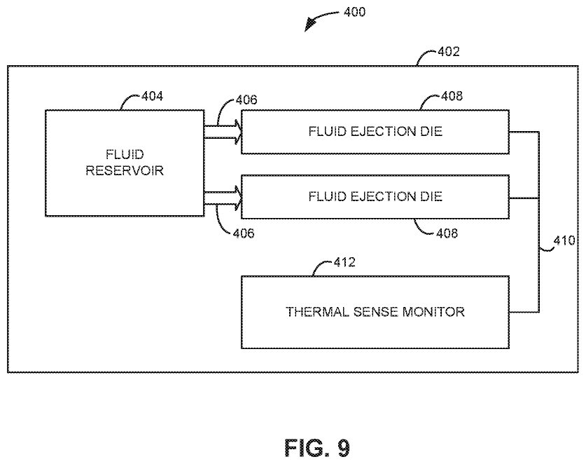

FIG. 9 is a block diagram illustrating another example of a fluid ejection device 400. Fluid ejection device 400 includes a housing 402, a fluid reservoir 404, at least two fluid ejection dies 408, and a thermal sense monitor 412. Each of the at least two fluid ejection dies 408 includes a temperature sensor and a local thermal sense line (not shown) electrically coupled to thermal sense monitor 412 through a shared thermal sense line 410. Thermal sense monitor 412 sequentially selects each temperature sensor of each of the at least two fluid ejection dies 408 to output a temperature signal to shared thermal sense line 410 and clips the temperature signal on shared thermal sense line 410 as previously described herein.

Fluid reservoir 404 supplies fluid to each of the at least two fluid ejection dies 408. In one example, fluid reservoir 404 supplies black ink to one fluid ejection die 408 and colored ink to another fluid ejection die 408. In other examples, multiple fluid reservoirs may be included to supply different colors of printing fluid to fluid ejection dies 408. As such, in one example, fluid flows from reservoir 404 to each fluid ejection die 408 through an interface connection 406, such as a supply tube and/or valve. In one example, fluid reservoir 404, the at least two fluid ejection dies 408, and thermal sense monitor 412 are housed together within housing 402 to form an inkjet or fluid-jet print cartridge or pen.

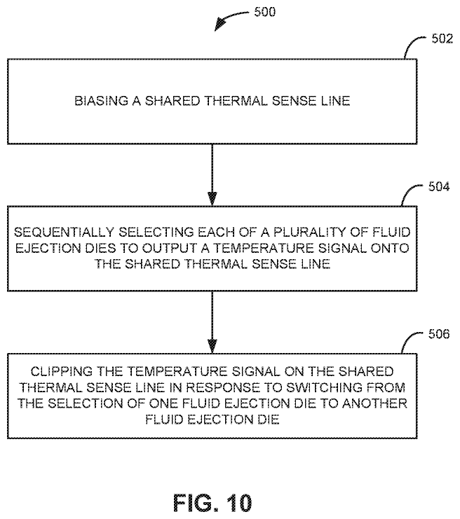

FIG. 10 is a flow diagram illustrating one example of a method 500 for monitoring the temperature of a plurality of fluid ejection dies. At 502, method 500 includes biasing a shared thermal sense line. At 504, method 500 includes sequentially selecting each of a plurality of fluid ejection dies to output a temperature signal onto the shared thermal sense line. At 506, method 500 includes clipping the temperature signal on the shared thermal sense line in response to switching from the selection of one fluid ejection die to another fluid ejection die.

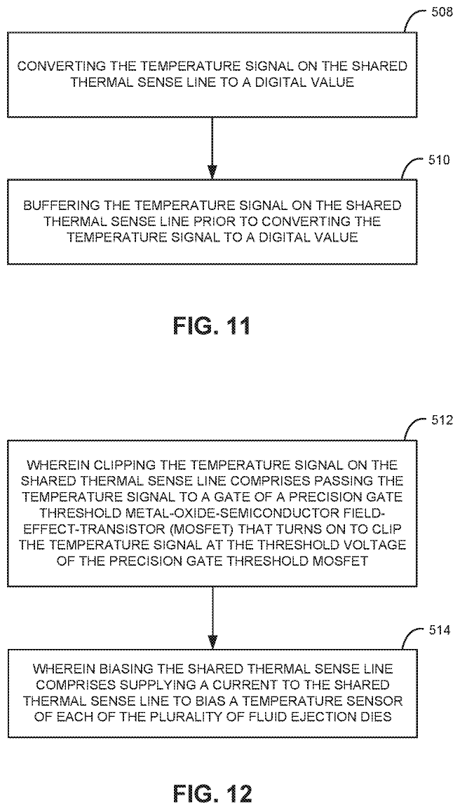

FIGS. 11 and 12 are flow diagrams illustrating example additional processes for method 500. At 508, method 500 may also include converting the temperature signal on the shared thermal sense line to a digital value. At 510, method 500 may also include buffering the temperature signal on the shared thermal sense line prior to converting the temperature signal to a digital value. At 512, clipping the temperature signal on the shared thermal sense line may include passing the temperature signal to a gate of a precision gate threshold metal-oxide-semiconductor field-effect-transistor (MOSFET) that turns on to clip the temperature signal at the threshold voltage of the precision gate threshold MOSFET. At 514, biasing the shared thermal sense line may include supplying a current to the shared thermal sense line to bias a temperature sensor of each of the plurality of fluid ejection dies.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A thermal sense monitor comprising:
a shared thermal sense line to sequentially receive a temperature signal from each of a plurality of fluid ejection dies;
a biasing circuit to supply a current to the shared thermal sense line to bias a temperature sensor of each of the plurality of fluid ejection dies; and
a clamping circuit electrically coupled to the shared thermal sense line to clip the temperature signal.

2. The thermal sense monitor of claim 1, further comprising:
a controller to sequentially select each of the plurality of fluid ejection dies to output a temperature signal from the temperature sensor of each of the plurality of fluid ejection dies to the shared thermal sense line.

3. The thermal sense monitor of claim 1, further comprising:
an analog to digital convertor to convert the temperature signal on the shared thermal sense line to a digital value.

4. The thermal sense monitor of claim 1, wherein the clamping circuit comprises:
a precision gate threshold metal-oxide-semiconductor field-effect-transistor (MOSFET) comprising a gate electrically coupled to the shared thermal sense line.

5. The thermal sense monitor of claim 4, further comprising:
a first resistor electrically coupled between the shared thermal sense line and the gate of the MOSFET; and
a second resistor electrically coupled between the gate of the MOSFET and a common or ground node.

6. A fluid ejection device comprising:
at least two fluid ejection dies, each of the at least two fluid ejection dies comprising a temperature sensor and a local thermal sense line electrically coupled to the temperature sensor;
a shared thermal sense line electrically coupled to the local thermal sense line of each of the at least two fluid ejection dies; and
a thermal sense monitor to sequentially select each temperature sensor of each of the at least two fluid ejection dies to output a temperature signal to the shared thermal sense line and to clip the temperature signal on the shared thermal sense line.

7. The fluid ejection device of claim 6, wherein the thermal sense monitor comprises:
a controller to sequentially select each temperature sensor of the at least two fluid ejection dies to output the temperature signal to the shared thermal sense line; and
a clamping circuit comprising a precision gate threshold metal-oxide-semiconductor field-effect-transistor electrically coupled to the shared thermal sense line to limit a voltage on the shared thermal sense line.

8. The fluid ejection device of claim 6, wherein the thermal sense monitor comprises:
a biasing circuit to supply a current to the shared thermal sense line to bias each temperature sensor of each of the at least two fluid ejection dies.

9. The fluid ejection device of claim 6, wherein the thermal sense monitor comprises:
a unity gain amplifier to buffer the temperature signal on the shared thermal sense line to provide a buffered temperature signal; and
an analog to digital converter to convert the buffered temperature signal to a digital temperature value.

10. The fluid ejection device of claim 6, wherein each temperature sensor of each of the at least two fluid ejection dies comprises a diode stack.

11. A method for monitoring the temperature of a plurality of fluid ejection dies, the method comprising:
biasing a shared thermal sense line;
sequentially selecting each of a plurality of fluid ejection dies to output a temperature signal onto the shared thermal sense line; and
clipping the temperature signal on the shared thermal sense line in response to switching from the selection of one fluid ejection die to another fluid ejection die.

12. The method of claim 11, further comprising:
converting the temperature signal on the shared thermal sense line to a digital value.

13. The method of claim 12, further comprising:
buffering the temperature signal on the shared thermal sense line prior to converting the temperature signal to a digital value.

14. The method of claim 11, wherein clipping the temperature signal on the shared thermal sense line comprises passing the temperature signal to a gate of a precision gate threshold metal-oxide-semiconductor field-effect-transistor (MOSFET) that turns on to clip the temperature signal at the threshold voltage of the precision gate threshold MOSFET.

15. The method of claim 11, wherein biasing the shared thermal sense line comprises supplying a current to the shared thermal sense line to bias a temperature sensor of each of the plurality of fluid ejection dies.
